(19) United States
(12) Patent Application Publication
(10) Pub. No.: US 2017/0011014 A1
(43) Pub. Date: Jan. 12, 2017

(54) SHARING USAGE OF RESOURCES WITH INTERESTED USERS

(71) Applicant: Microsoft Technology Licensing, LLC, Redmond, WA (US)

(72) Inventors: Christian Liensberger, Bellevue, WA (US); James Eldon Tillinghast, Seattle, WA (US); Mark Wade Heninger, Preston, WA (US); Christina Storm, Seattle, WA (US); Chairy Chiu Ying Cheung, Redmond, WA (US)

(21) Appl. No.: 14/794,043

(22) Filed: Jul. 8, 2015

(51) Int. Cl. G06F 17/22; G06F 17/24; H04L 29/08

(52) U.S. Cl. CPC G06F 17/2247; H04L 67/02; G06F 17/241

(57) ABSTRACT

While interacting with resources such as databases and data sets, a user of an organization may create a usage of a resource that is interesting or has value. The user may publish the usage to a web page and/or notify other users who may be interested in the usage, but the effectiveness of such sharing depends upon the user's volition to share the usage with interested users. Instead, the interaction between the interacting user and the resource may be monitored to detect a usage of the resource that may be interesting to other users of the organization. Interested users may be automatically identified and notified of the resource usage, and may request a replay of the resource usage by the interacting interested user. Usages may also be automatically stored as part of a catalog of resource usages by the interacting user for interested users to browse and replay.

### BACKGROUND

Within the field of computing, many scenarios involve an interaction of an interacting user of an organization with a resource, such as the creation, addition, and/or querying of a database, or a navigation of a user through a data set. In these scenarios, the usage of the interacting user may have a particular value or may yield an interesting result; e.g., a view of a particular data set may reveal information about the data set that is not apparent through cursory inspection.

In such scenarios, the interacting user may choose to store the results of the interaction, e.g., by forwarding a resulting data set to interested users, or by recording the particular query that produced the interesting result. The interacting user may choose to generate a set of such usages and/or results, such as storing the usage in a shared file or publishing the usage or results to a web page. The interacting user may also choose to notify other users of the organization about the usage. In this manner, the interacting user's usage may be shared with other users of the organization, and/or the interested users may serendipitously discover the usage of the resource by the interacting user within the organization.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While interacting users may take many actions to share a usage of a resource with interested users, a number of limitations may arise in such scenarios. As a first example, the interacting user may not recognize that the usage may be interesting to anyone but the interacting user, and it may not occur to the interacting user to share the usage with anyone else within the organization. As a second example, the interacting user may not know which other users within the organization may be interested in the usage of the resource (e.g., which members of the organization are involved in the creation, administration, and/or usage of the resource), either because the interacting user does not know the second user, or the interacting user is not aware that the second user is interested in usage of the resource. As a third example, the interest of the second user in the usage of the resource may develop after the interaction (e.g., months or years after the interaction of the interacting user with the resource), by which time the interacting user may simply have forgotten about the usage and/or removed the usage from sharing. As a fourth example, the interacting user may share the usage (e.g., publishing the usage to the user's web page), but the interested user may not actively discover the usage, either within any time frame, or not until a later time, by which point the usage may no longer be relevant.

Presented herein are techniques for assisting the sharing of usages of a resource by an interacting user with interested users who are interested in the resource.

As a first example of these techniques, responsive to an interaction of an interacting user of the organization with the resource, a device may monitor the interaction to detect a usage of the interacting user with the resource, and stores the usage of the interacting user with the resource. The device may also notify the interested user of the usage of the interacting user with the resource, and, responsive to receiving from the interested user a request to describe the interaction, may replay the usage of the interacting user with the resource for the interested user.

As a second example of these techniques, for an interacting user of the organization, a device may monitor an interaction of the interacting user with the resource to detect a usage of the interacting user with the resource, and determine whether the interested user is interested in the usage of the resource. Responsive to determining that the interested user is interested in the usage of the resource, the device may notify the interested user of the usage of the resource by the interacting user, and replay the usage of the interacting user with the resource for the interested user.

As a third example of these techniques, a device may monitor an interaction of an interacting user of the organization with a resource to detect a usage of the interacting user with the resource, and store the usage in a usage catalog of the interacting user. The device may the usage catalog of the interacting user with respective resources to an interested user of the organization; and, responsive to a selection by the interested user of a selected usage, replay the selected usage of the interacting user with the resource for the interested user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring a usage of a resource by an interacting user, and a notification and/or discovery of the usage by an interested user.

FIG. 2 is an illustration of an example scenario featuring an informing of an interested user of a device about a usage of a resource by an interacting user

FIG. 3 is an illustration of an example device featuring an example system for informing an interested user of a device about a usage of a resource by an interacting user, in accordance with the techniques presented herein.

FIG. 4 is an illustration of a first example method for informing an interested user of a device about a usage of a resource by an interacting user, in accordance with the techniques presented herein.

FIG. 5 is an illustration of a second example method for informing an interested user of a device about a usage of a resource by an interacting user, in accordance with the techniques presented herein.

FIG. 6 is an illustration of an example memory device storing instructions that cause a device to inform an interested user of a usage of a resource by an interacting user, in accordance with the techniques presented herein.

FIG. 7 is an illustration of example scenarios featuring variations in the identification and recording of usages of a resource by one or more interacting users, in accordance with the techniques presented herein.

FIG. 8 is an illustration of example scenarios featuring variations in the identification of interested users of an organization to be notified of a usage of a resource by an interacting user, in accordance with the techniques presented herein.

FIG. 9 is an illustration of example scenarios featuring variations in the notification of an interested user of usages of resources by interacting users of an organization, in accordance with the techniques presented herein.

FIG. 10 is an illustration of an example scenario featuring the involvement of interested users of the organization in the notification of usages of resources outside of the organization, in accordance with the techniques presented herein.

FIG. 11 is an illustration of an example scenario featuring a computing environment within which the techniques presented herein may be implemented and/or utilized.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

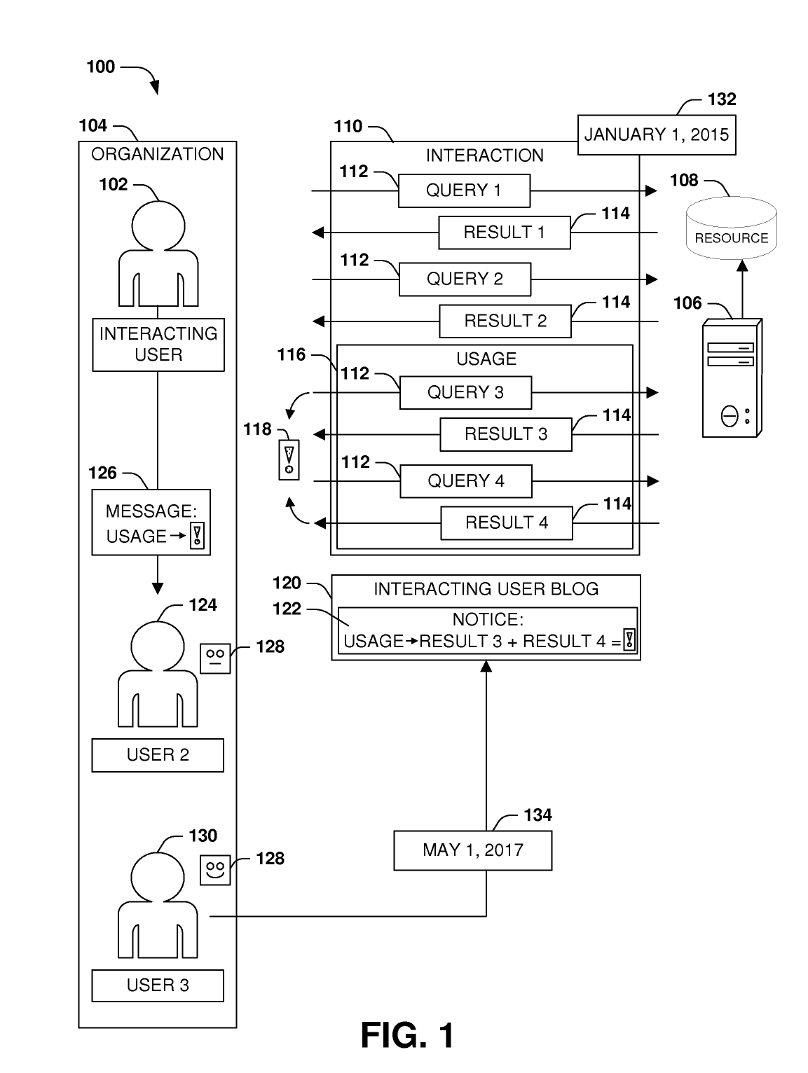

FIG. 1 is an illustration of an example scenario 100 featuring an interaction 110 of between a resource 108 and an interacting user 102 within an organization 104. In this example scenario 100, the resource may comprise, e.g., a database, data set, or a media item, and the interaction 110 of the interacting user 102 with the resource 108 may involve a variety of queries 112 to a device 106 managing the resource 108, such as generation of the resource 108 through the addition of pieces of data; navigation through the resource 108 through various navigational operations, such as a sequence of search queries submitted to a search engine, a pivot or “drill-down” operation or operation sequence within a hierarchical data set, or a stepwise navigation through a map; transformation of the resource 108 through the modification of data; and/or generation of a view or report based on the contents of the resource 108. In response to the queries 112, the device 106 may perform various actions on the resource 108, and may provide a result 114 in response to each query 112, such as a set of query results, a new or updated view of the resource 108 as requested in the query 112, or an acknowledgment of the query 112 and a report of the application of a requested action to the resource 108.

In this example scenario 100, the interaction 110 of the user 102 with the resource 108 may result in a particular usage 116 that the interacting user 102 identifies as of interest 118, such as a set of queries 112 that result in an interesting report or data set, or an interesting result 114 of applying a requested action to the resource 108 responsive to a set of queries 112. The interacting user 102 may therefore seek to share the usage 116 with other users 124 within the organization 104 who may be interested in the usage 116 of the resource 108. As a first such example, the interacting user 102 may publish the usage 116 to a source that is accessible by other users 124 of the organization 104, such as adding to a blog 120 of the interacting user 102 a notice 122 describing the usage 116 and the observations of the interacting user 102 as to why the usage 116 is of interest 118. As a first such example, where the resource 108 comprises a database, the interacting user 102 may publish a set of relational data queries that provide query results that are of interest 118 to the interacting user 102; and where the resource 108 comprises a data set, the interacting user 102 may publish a view of the data set that reveals observations that the interacting user 102 finds to be of interest 118. The interacting user 102 may therefore hope that other users 124 of the organization 104 read the blog 120 and discover the notice 122 of the interesting usage 116. As a second such example, the interacting user 102 may believe that a second user 124 within the organization 104 may also find the usage 116 to be of interest 118, and may send a message 126 to the second user 124 describing the usage 116. In these and other ways, the interacting user 102 may endeavor to notify other users 124 within the organization 104 of the usage 116 of the resource 108.

However, as further illustrated in the example scenario 100 of FIG. 1, the sharing of the usage 116 of the resource 108 by the interacting user 102 may be limited by the volition of the interacting user 102 in initiating such sharing. As a first such example, the interacting user 102 may send a message 126 to the second user 124 about the usage 116, but the personal interest 128 of the second user 124 in the usage 116 may be poor, so the second user 124 may be irritated by and/or may disregard or delete the message 126. As a second such example, an interested user 130 may exist within the organization 104 who has a personal interest 128 in the usage 116, but the interested user 130 may not be acquainted with the interacting user 102. Alternatively, the interacting user 102 may be acquainted with the interested user 130, but may not realize that the interested user 130 may have a personal interest 128 in the usage 116. Accordingly, the interacting user 102 and the second user 124 may fail to notify the interested user 130 of the usage 116. As a third such example, the publication of the notice 112 to an accessible source, such as a blog 120, may not be discovered by the interested user 130 in a timely manner; e.g., the interested user 130 may not ever discover the blog 120, or may discover the notice 122 at a second time 134 that is considerably after the first time 132 of the usage 116, and the usage 116 may no longer be relevant or of interest 118. As a fourth such example (not shown), the interacting user 130 may simply not appreciate the interest 118 of the usage 116; may not realize that anyone other than the interacting user 102 may have an interest 116 in the usage 116; may not remember to notify anyone else of usage 116; and/or may not correctly remember or describe the details of the usage 116 that led to the result 114 that the interacting user 102 found to be of interest 118. These and other limitations may arise from the sharing of usages 116 of resources 108 according to the volition of the interacting user 102 as shown in the example scenario 100 of FIG. 1.

### B. Presented Techniques

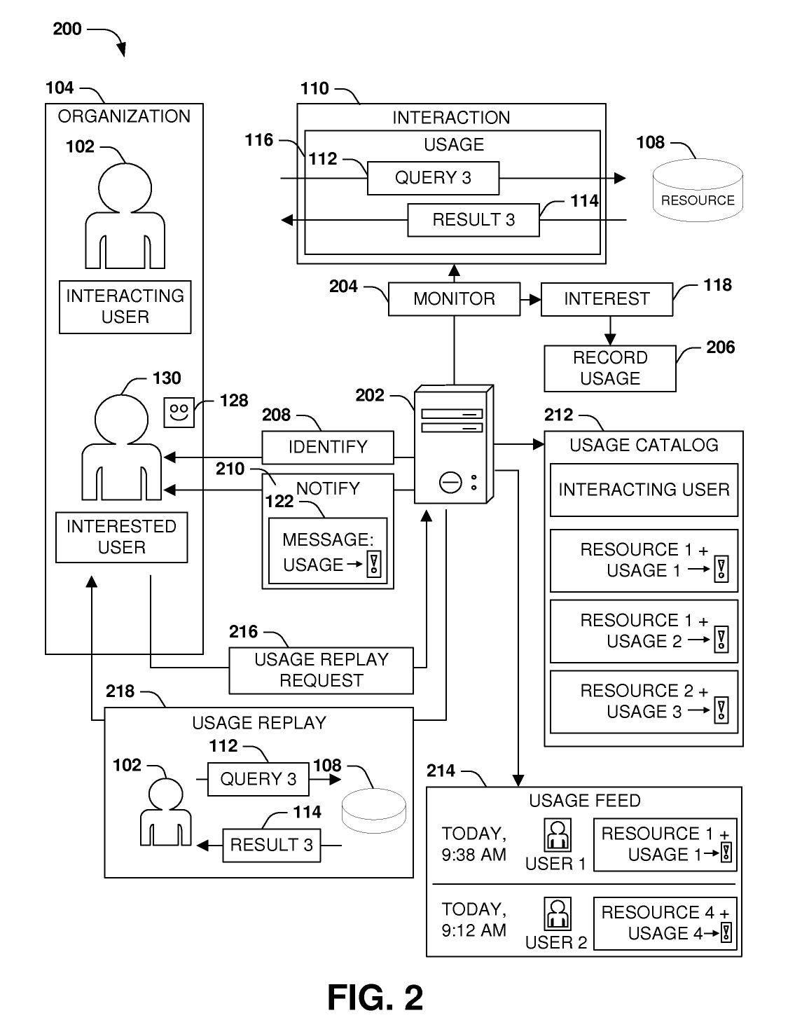

FIG. 2 presents an illustration of an example scenario 200 featuring various techniques for notifying interested users 130 within an organization 104 of the usages 116 of resources 108 by interacting users 102 of the organization 104, in accordance with the techniques presented herein.

In this example scenario 200, an interacting user 102 engages in an interaction 110 with a resource 108 that results in a usage 116 (e.g., an exchange of a query 112 and a result 114) that may be of interest 118 to one or more interested users 130 of the organization 104. In order to share the usage 116 with the interested users 130, a device 202 may monitor 204 the interaction 110 of the interacting user 102 with the resource 108 to detect a usage 116 of the resource 108 by the interacting user 102. The device 202 may also automatically determine the interest 118 of the usage 116 (e.g., that the usage 116 provided a result 114 that the interacting user 102 or an interested user 130 may find interesting and/or valuable, or that prompted an unusual or unexpected reaction by the resource 108), and, responsive to such determination, may automatically record 206 the usage 116 of the resource 108 by the interacting user 102. The device 202 may automatically identify 208 an interested user 130 within the organization 104 who may share the interest 118 in the usage 116, e.g., a personal interest 128 in the resource 108, the activities of the interacting user 102, the queries 112 of the usage 116, and/or the results 114 of the usage 116. The device 202 may therefore notify 210 the interested user 130 of the usage 116 that is of interest 118, e.g., by automatically sending a message 122 describing the usage 116 of the resource 108 by the interacting user 102, and/or why the interaction 116 may be of personal interest 128 to the interested user 130. Additionally, if the interested user 130 initiates a usage replay request 216 to replay the usage 116 leading to the result of interest 118, the device 202 may initiate a usage replay 218 of the usage 116, i.e., a reconstruction of the sequence of queries 112 and the results 114 of each such query 112 that prompted the determination that the usage 116 is of interest 118.

As further illustrated in the example scenario 200 of FIG. 2, the device 202 may also share the usage 116 with interested users 130 within the organization 104 in other ways. As a first such example, the device 202 may automatically add the usage 116 to a usage catalog 212 of the interacting user 102 that describes usages 116 by the interacting user 102 of various resources 108 that are of interest 118. For example, the interacting user 102 may be searching through a database or data set for data matching a certain set of criteria, and when the interacting user 102 formulates a query 112 that provides a result 114 satisfying the criteria, the device 202 may automatically add the query 112 to the usage catalog 212. An interested user 130 may then access the usage catalog 212 to view a complete set of usages 116 of various resources 108 by the interacting user 102. As a second such example, the device 202 may present to interested users 130 of the organization 104 a usage feed 214 indicating the usages 116 of various resources 108 by interacting users 102 of the organization 104, where the usage feed 214 may be sorted and/or filtered, e.g., by the dates of the respective usage 116, the resource(s) 108 involved in the respective usages 116, the results 114 of respective usages 116, the context in which the respective usages 116 arose, the sets of interested users 130 who may pave a personal interest 128 in the respective usages 116, and/or the interest basis upon which the respective usages 116 are determined to be of interest 118. These and other ways of notifying interested users 130 of the usages 116 of resources 108 by the interacting users 102 of the organization 104 may be devised and implemented in accordance with the techniques presented herein.

### C. Technical Effects

Various uses of the techniques presented herein to notify interested users 130 of usages 116 of resources 108 by interacting users 102 of an organization 104 may result in a variety of technical effects.

As a first technical effect, an automated determination by the device 202 that a usage 116 is of interest 118 may enable the device 202 to initiate an automatic recording 206 of the usage 116, which may enable a later usage replay 218. Automatically triggered recording may enable a capturing of the usage 116 in circumstances where the usage 116 may not otherwise be recorded, e.g., if the interacting user 102 does not identify that the usage 116 is of interest 118; if the interacting user 102 is not aware of the usage recording capabilities of the device 202; and/or if the interacting user 102 only later realizes a desire to record the usage 116, but where the circumstances have changed such that the usage 116 cannot be repeated for recording (e.g., where the usage 116 is of interest 118 because the result 114 reflects the internal state of the resource 108, but where the internal state has changed by the time the interacting user 102 realizes a desire to capture it).

As a second technical effect, an automated determination of which users 124 of the organization 104 comprise interested users 130 who may have a personal interest 128 in the usage 116 may provide a more complete and accurate notification of the interested users 130 (including a reduction of second users 124 whom the interacting user 102 believes to have an 118 interest in the usage 116). As a first such example, automatically determining the interest 128 of the respective users 124 of the organization in the usage 116 may enable the device 106 to notify interested users 130 automatically, and/or to forgo notifying second users 124 who do not have a personal interest 128 in the usage 116 or the resource 108. As a second such example, automatically determining the interest 128 of the respective users 124 may enable interested users 130 to be notified even if the interacting user 102 has not met the interested user 130, or if the interacting user 102 has met the interested user 130 but has not learned (or ahs forgotten) that the interested user 130 has a personal interest 128 in the resource 108. The determination of the personal interests 128 of the respective users 124, and the determination of how such personal interests 128 match up with the reasons by which the usage 116 may be of interest 118 to the interested user 130 with the resource 108, may be informed by a variety of data about the interested user 130 that enables a more accurate determination of personal interest 128 than expressions (such as web searches) and/or the memory of each user 124 of the organization 104. Moreover, an automated determination may be performed rapidly, and may notify interested user(s) 130 of the usage 116 promptly upon its completion and/or identification as of interest 118, while notification based upon the volition of the interacting user 102 may be significantly delayed by limitations on the travel of the interacting under 102.

As a third technical effect, the techniques presented herein may enable the device 202 to generate an automated notice record of the usage 116 in various ways, such as automatically posting a notification of the usage 116 to a usage catalog 212 of the interacting user 102; and/or automatically presenting a usage replay 218 of the usage 116 for the interested user 130. Such techniques may memoralize the usage 116 more broadly than the interacting user 102 may achieve by volition, and/or may save the interacting user 102 time and energy in promoting the sharing of the record 206 of the usage 116 than may be achieved by human-led volition (e.g., the interacting user 102 may not be aware of all of the different ways of sharing the usage 116 with other users 124 of the organization 104). These and other technical effects are achievable by evaluating usages 116 of resources 108 in accordance with the techniques presented herein.

### D. Example Embodiments

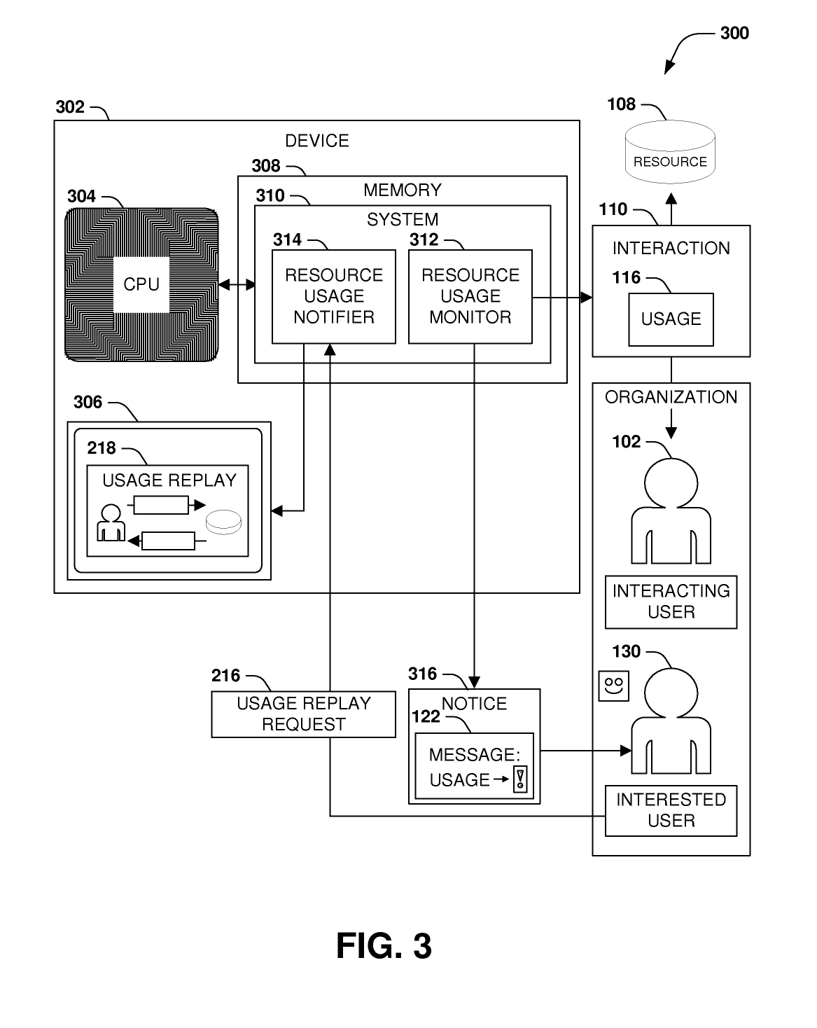

FIG. 3 presents a first example embodiment of the techniques presented herein, illustrated as an example device 302 featuring a sample system 310 that causes the example device 302 to notify users 130 of the usage 116 of the resource 108 in accordance with the techniques presented herein.

In the example scenario 300 of FIG. 3, a device 302 having a processor 304, a display 306, and a memory 308 is utilized by an interested user 130 of an organization 104 to receive notifications of various usages 116 of the resource 108 by the interacting users 102 of the organization 104. An interacting user 102 engages in an interaction 110 with a resource 108 that results in a usage 116 that is determined to be of interest 118, such as a particular sub-sequence of queries within a query sequence that provide an interesting kind of data. The device 302 may utilize the example system 310 stored in the memory 308 to achieve the notification of interested users 130 of the usage 116 by the interacting user 102. The example system 310 comprises a resource usage monitor 312, which, responsive to an interaction 110 of the interacting user 102 of the organization 104 with the resource 108, monitors 204 the interaction 110 to detect a usage 116 of the interacting user 102 with the resource 108 that is of interest 118, and stores or records 206 the usage 116 of the interacting user 102 with the resource 108. The example system 310 also comprises a resource usage notifier 314, which notifies the interested user 130 of the usage 116 of the interacting user 102 with the resource 108; and, responsive to receiving from the interested user 130 a usage replay request 216 to describe the interaction 110, replays on the display 306, for the interested user 130, the usage 116 of the resource 108 by the interacting user 102. In this manner, the example system 310 enables the example device 302 to notify the interested user 130 of the usages 116 of the resource 108 by interacting users 102 of the organization 104 that are of interest 118 to the interested user 130, in accordance with the techniques presented herein.

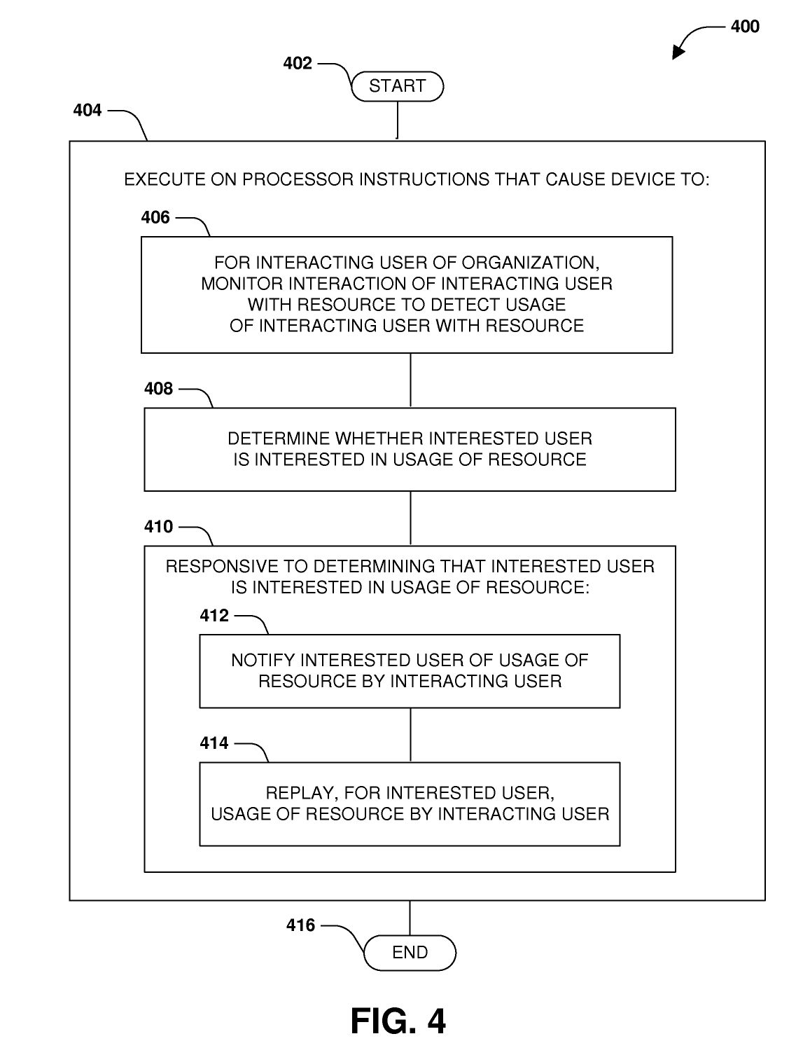

FIG. 4 presents a second example embodiment of the techniques presented herein, illustrated as an example method 400 of describing usages 116 of a resource 108 to an interested user 130 within an organization 104 by interacting users 102 of the organization 104. The example method 400 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 400 begins at 402 and involves executing 404 the instructions on a processor of the device. Specifically, executing 404 the instructions on the processor causes the device to, for an interacting user 102 of the organization, monitor 406 an interaction 110 of the interacting user 102 with the resource 108 to detect a usage 116 of the interacting user 102 with the resource 108. Executing 404 the instructions on the processor also causes the device to determine 408 whether the interested user 130 is interested in the usage 116 of the resource 108. Executing 404 the instructions on the processor also causes the device to, responsive 410 to determining 408 that the interested user 130 is interested in the usage 116 of the resource 108 by the interacting user 102, notify 412 the interested user 130 of the usage 116 of the resource 108 by the interacting user 102; and replay 414, for the interested user 130, the usage 116 of the resource 108 by the interacting user 102. In this manner, the example method 400 enables the device to describe to the interested user 130 the usages 116 of the resource 108 by the interacting users 102 of the organization 104, and so ends at 416.

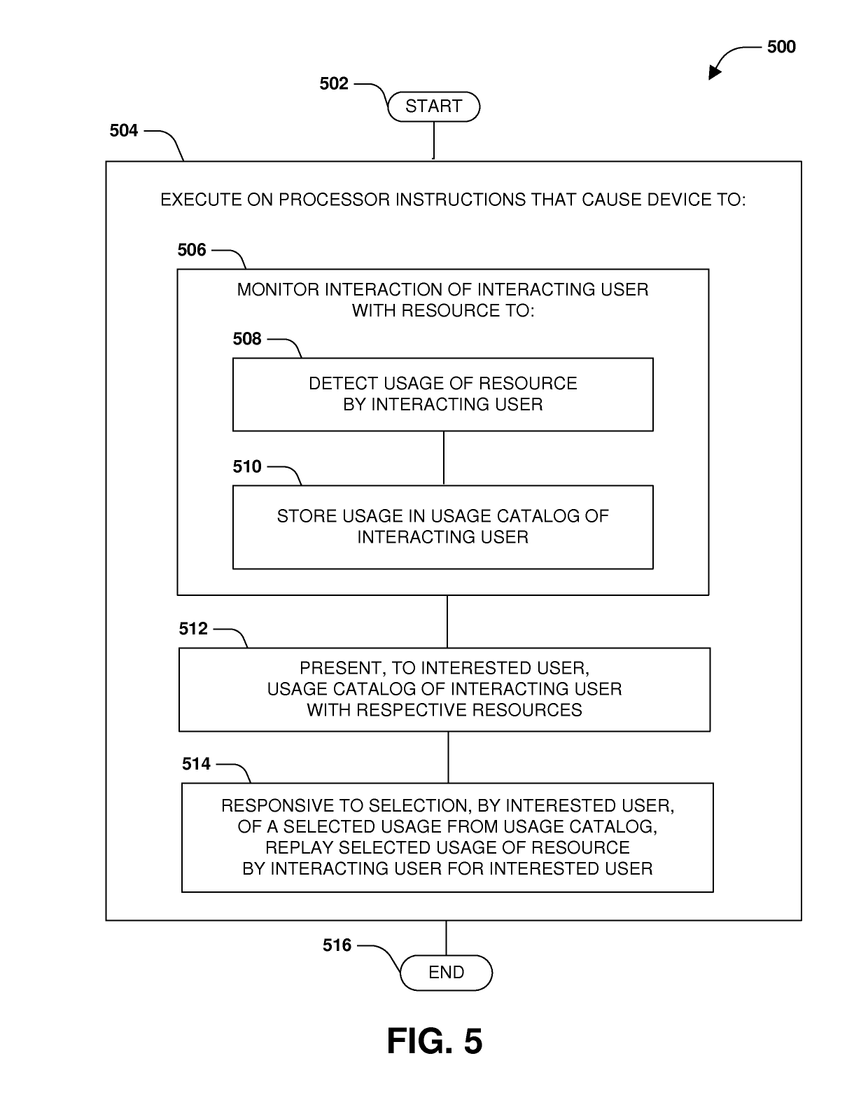

FIG. 5 presents a second example embodiment of the techniques presented herein, illustrated as an example method 500 of presenting usages 116 of resources 108 to an interested user 130 within an organization 104 by interacting users 102 of the organization 104. The example method 500 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 500 begins at 502 and involves executing 504 the instructions on a processor of the device. Specifically, executing 504 the instructions on the processor causes the device to monitor 506 an interaction 110 of an interacting user 102 of the organization 104 with a resource 108, in order to detect 508 a usage 116 of the resource 108 by the interacting user 102, and store 510 the usage 116 in a usage catalog 212 of the interacting user 102. Executing 504 the instructions on the processor further causes the device to present 512, to the interested user, the usage catalog of the interacting user with respective resources. Executing 504 the instructions on the processor further causes the device to, responsive to a selection, by the interested user 130, of a selected usage 116 from the usage catalog 212, replay 514 the selected usage 116 of the resource 108 by the interacting user 102 for the interested user 130. In this manner, the example method 400 enables the device to describe to the interested user 130 the usages 116 of various resources 108 by the interacting users 102 of the organization 104, and so ends at 516.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

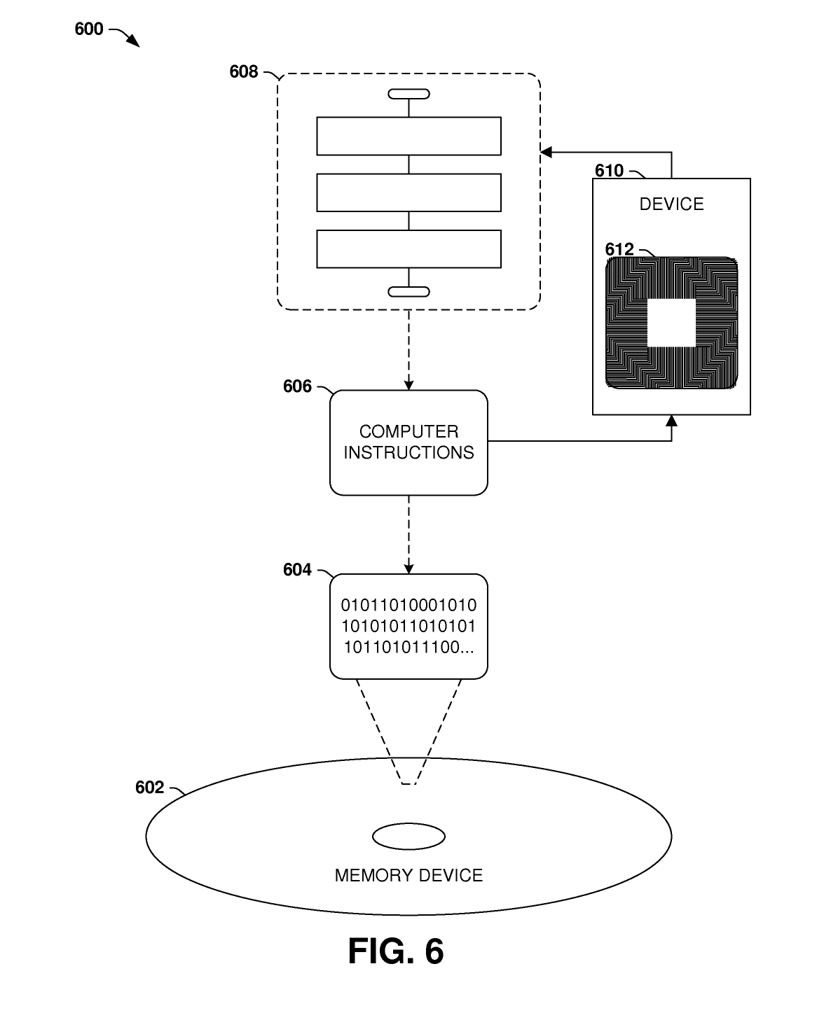

An example computer-readable medium that may be devised in these ways is illustrated in FIG. 6, wherein the implementation 600 comprises a memory device 502 (e.g., a CD-R, DVD-R, or a platter of a hard disk drive), on which is encoded computer-readable data 604. This computer-readable data 604 in turn comprises a set of computer instructions 506 that, when executed on a processor 608 of a device 610, cause the device 610 to operate according to the principles set forth herein.

In a first such embodiment, the processor-executable instructions 606 may create in a memory 308 of the device 302 a system that notifies interested users 130 of the usage 116 of a resource 108 by interacting users 102 of an organization 104 in accordance with the techniques presented herein, such as the example system 310 in the example scenario 300 of FIG. 3.

In a second system embodiment, the processor-executable instructions 606 may provide a system that causes a device to describe for an interested user 130 a usage 116 of a resource 108 by an interacting user 102 of an organization 104 in accordance with the techniques presented herein, such as the example method 400 in the example scenario 400 of FIG. 4.

In a third such example, the processor-executable instructions 606 may cause a device to perform a method of presenting usages 116 of resources 108 by the interacting users 102 of an organization 104 to an interested user 130 of the organization 104 in accordance with the techniques presented herein, such as the example method 500 of FIG. 5. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example system 310 of FIG. 3; the example method of FIG. 4; the example method 500 of FIG. 5; and/or the example memory device 602 of FIG. 6) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices and servers, such as workstations, laptops, tablets, mobile phones, game consoles, portable gaming devices, portable or non-portable media players, media display devices such as televisions, appliances, home automation devices, computing components integrated with a wearable device integrating such as eyewear or a watch, and supervisory control and data acquisition (SCADA) devices.

As a second variation of this first aspect, the techniques presented herein may be utilized to notify interested users 130 of usages 116 of resources 108 by interacting users 102 in many types of organizations 104, such as public and/or private companies; international, national, and/or local governments and/or regulatory bodies; non-profit institutions, such as schools and hospitals; social communities, such as the members of a township or a club; and social networks, such as friends and families.

As a third variation of this first aspect, the techniques presented herein may be utilized to notify interested users 130 of usages 116 of many types of resources 108, such as databases and data sets; media items, such as recordings and/or libraries of text, audio, pictures, and/or video; content sources, such as web pages or websites; one or more processes or applications executing on a device; one or more physical devices, such as device peripherals sensors, and/or autonomous robots; and one or more real and/or virtual environments. Respective resources 108 involved in the interaction may also be owned, managed, maintained, licensed by, secured by, and/or stored within the organization 104, and/or may be external to the organization 104, such as a publicly provided database or data set that is of interest to a particular organization 104, and with which various interacting users 102 generate usages 116 that are of interest 118 to interested users 130 of the organization 104.

As a fourth variation of this first aspect, an interacting user 102 and/or the interested user 130 may have various roles in the context of the interaction with the resource 108, such as an administrator, owner, customer, client, end user, subject, analyst, beneficiary, and/or unauthorized user of the resource 108. Additionally, respective interacting users 102 may have various relationships with the interested user 130, such as peer members of the organization 104; a superior/subordinate relationship within the organization 104; members of the same organizational unit, such as department or class; members of the organization 104 that have coinciding interests, such as corresponding roles for different organizational units within the organization 104; and/or a provider/client relationship, such as a customer of the organization 104 and a representative designated to serve the customer.

As a fifth variation of this first aspect, the techniques presented herein may enable the notification of the interested user 130 regarding many types of usages 116 of the resource 108 by the interacting user 102, such as the creation, insertion, updating, and/or deletion of data, or of the resource 108 itself; a view or navigation through the resource 108, such as a stepwise navigation through a map, or a pivot or “drill-down” operation or operation sequence in a hierarchical data set; an observation about the resource 108, such as a performance characteristic, a feature, an expected or unexpected behavior, a vulnerability, and/or a malfunction of the resource 108 in a particular context; a configuration, feature, behavior, or result achieved by the interacting user 102 through the interaction 110 with the resource 108; and a performance by the user 102 within, using, relating to, or otherwise in connection with the resource 108. Many such scenarios may be devised wherein the techniques presented herein may be utilized.

E2. Detecting and Recording Usages

A second aspect that may vary among embodiments of the techniques presented herein involves the detection of usages 116 within an interaction 110 of an interacting user 102 with a resource 108, and the manner of recording the usage 116 of the resource 108 by the interacting user 102.

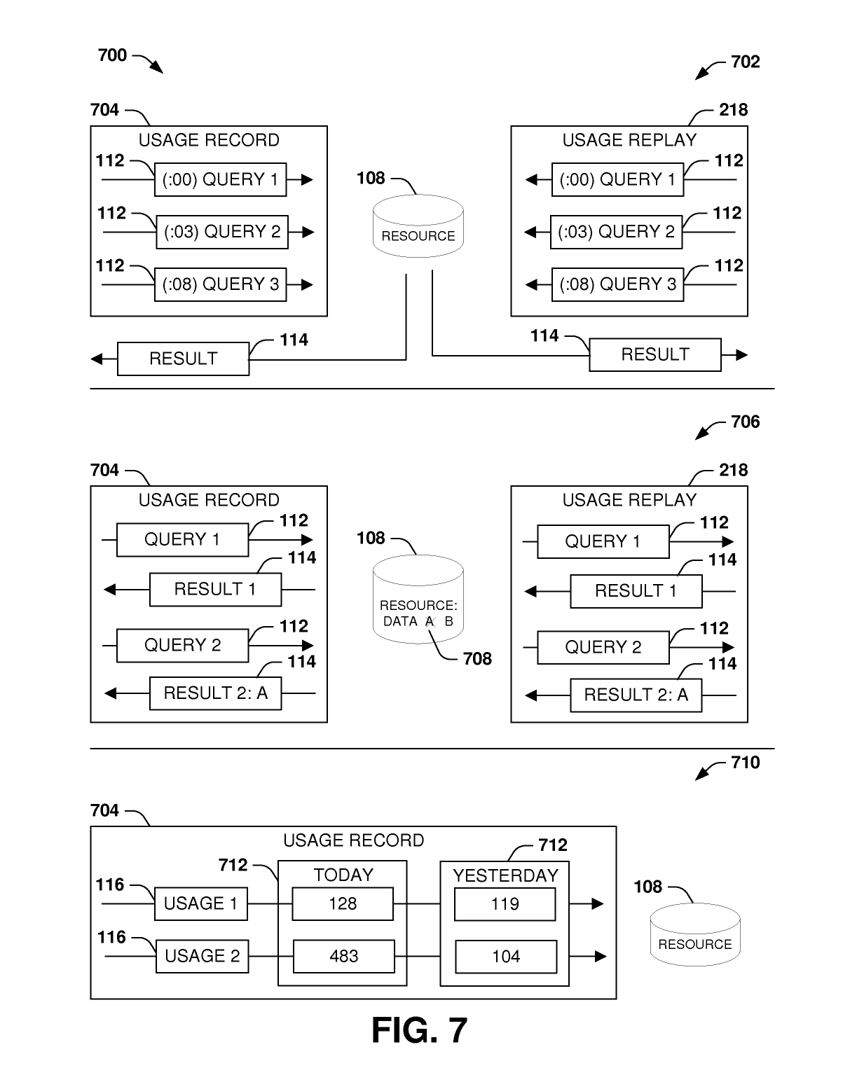

FIG. 7 presents an illustration of an example scenario set 700 featuring several examples of the detection and recording of usages 116 of a resource 108 by an interacting user 102.

In a first example scenario 702 of FIG. 7, the interaction of the interacting user 102 with the resource 108 further comprises an interaction sequence of at least two actions invoked by the interacting user 108 upon the resource 108, such as a sequence of queries 112 presented by the interacting user 102 to the resource 108 that are respectively fulfilled as a query result 114. An embodiment of the techniques presented herein may, responsive to determining that a particular result 114 is of interest 118 to at least one interested user 130 of the organization 104, store the at least two actions comprising the interaction sequence of the interacting user 102 with the resource 108. For example, the embodiment may generate a usage record 704 comprising a set of queries 112 within an interaction 110 that directly contributed to the result that the resource usage notifier replays, for the interested user, the interact 114 that is of interest. The interaction sequence of the at least two actions of the interacting user 102 with the resource 108, and may be presented to, summarized, and/or replayed for an interested user 130 (e.g., at the request of the interested user 130, the sequence of queries 112 may be re-executed to present the results 114 for the interested user 130. Moreover, the actions of the usage 116 may be recorded with varying levels of detail; e.g., for a sequence of queries 112, the relative timing of the respective queries 112 may be recorded and replicated during the usage replay 218 in order to replay the usage 116 with high fidelity to the original interaction 110.

In a second example scenario 706 of FIG. 7, in addition to recording the actions comprising the usage 116 of the resource 108 by the interacting user 102, an embodiment may detect that respective actions of the interacting user 102 with the resource 108 result in a response by the resource 108 to the action (e.g., the resource 108 may report a result 114 of a query 112), and may store the responses of the resource 108 to the respective actions. Accordingly, the usage replay 218 may include the responses of the resource 108 to the respective actions. That is, a sequence of queries 112 may be interesting due to the results 114 reported by the resource 108 arising from its internal state at the time of the usage 116; and by the time the interested user 130 requests a usage replay 218, the internal state may have changed 708, such as an update of the data, that causes the usage replay 218 to provide a different result 114 if replayed through the resource 108. Instead, the usage replay 218 may record and use the responses of the resource 108 at the time of the usage 116 in order to preserve the aspect of the interaction 110 that causes the usage 116 to be of interest 118 to the interested user 130.

In a third example scenario 710 of FIG. 7, respective interactions of interacting users 102 with the resource 108 may occur at an interaction time that is within a time range 712, such as interactions 110 within a 24-hour period. An embodiment of the techniques presented herein may record the respective usages 116 of the resource 108 in a usage catalog 212 of usages 116 of the resource 108 occurring within the time range 712, such as the number, kinds, and/or trends of usages 116 occurring within each 24-hour time period. Many such variations may be included in the detection and/or recording of a usage 116 within an interaction 110 of an interacting user 102 with a resource 108 in accordance with the techniques presented herein.

E3. Identifying Interested Users of Interesting Resource Usage

A third aspect that may vary among embodiments of the techniques presented herein involves the identification of interested users 130 of the organization 104 who have an interest 118 in the usage 116 of the resource 108 by the interacting user 102.

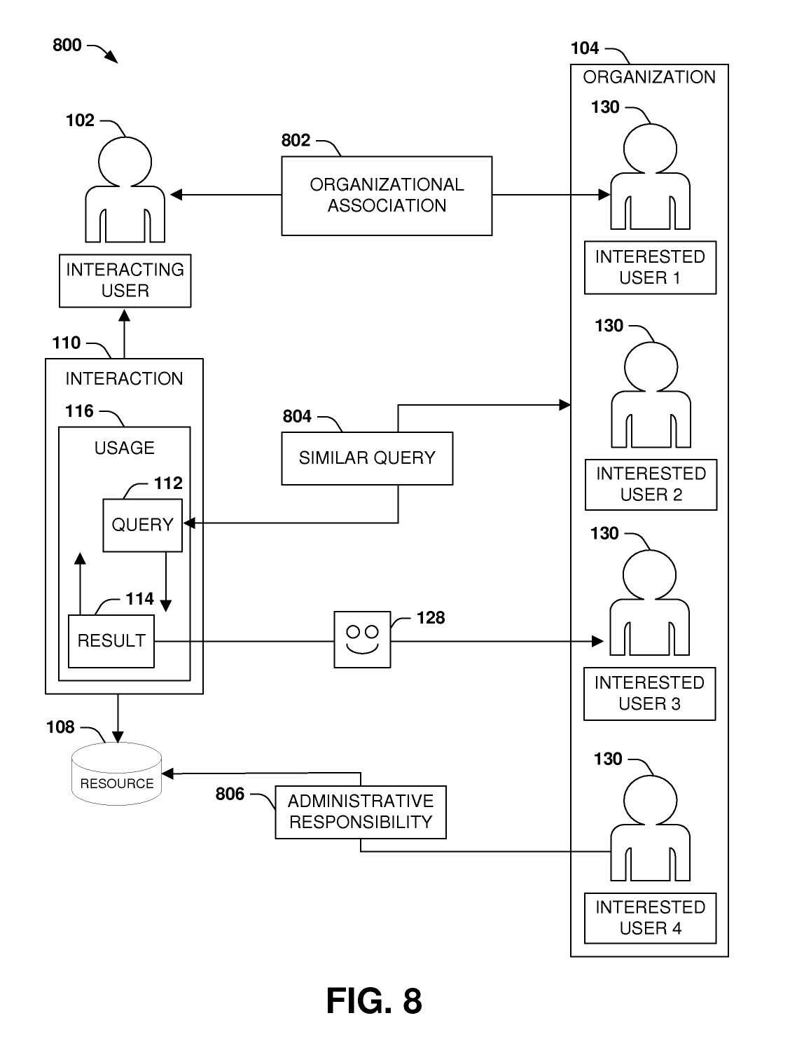

FIG. 8 presents an illustration of an example scenario 800 featuring various criteria by which, for a usage 116 of a resource 108 by an interacting user 102 of an organization 104, various other users 124 of an organization 104 may be identified as interested users 130 in the usage 116. In this example scenario 800, the interacting user 102 engages in an interaction 110 with a resource 108, such as a submission of a sequence of queries 112 and the production of results 114 by the resource 108, which results in an identification that the usage 116 is of interest 118. An embodiment of the techniques presented herein may review various other users 124 of the organization 104 to determine which such other users 124 may regard the usage 116 as of interest 118.

As a first variation of this third aspect, determining whether the interested user 130 is interested in the usage 116 of the resource 108 may involve identifying an association 802, within the organization 104, between the interacting user 130 and the interested user 102. For example, the interested user 102 may comprise a superior, subordinate, mentor, student, friend, colleague within the same organizational unit, or client of the interested user 130, and by virtue of this association 802, the interested user 130 may wish to be notified of any usages 116 by the interacting user 102 that are determined to be of interest 118. As one such example, an embodiment may identify, according to an organization directory, interested users 130 who serve the organization 104 in the same role as the interacting user 102, and may inform all such interested users 130 of the usage 116 that is of interest to anyone in such an organizational role.

As a second variation of this third aspect, determining whether the interested user 130 is interested in the usage 116 of the resource 108 may involve determining that the interested user 130 is an administrator of the resource 108 involved in the usage 116. For example, the interested user 130 may bear an administrative responsibility 806 over the resource 108 (e.g., maintaining the performance, availability, and/or security of the resource 108), and the usage 116 may indicate an improvement and/or reduction of such aspects of the resource 108 for which the interested user 130 bears the administrative responsibility 806, so the usage 116 is determined to be of high predicted interest 118 to the interested user 130.

As a third variation of this third aspect, an interested user 130 may be determined to be interested in a usage 116 based on the personal interests 128 and activities of the user 128 that relate to the usage 116. As a first such example, before, concurrent with, and/or after the usage 116 by the interacting user 102, an interested user 130 may initiate a second interaction with the resource 108 that has some relation to the usage 116 (e.g., a similar query 804 of a data set that is similar to the query 112 submitted by the interacting user 102). An embodiment of the techniques presented herein may compare the second interaction of the interested user 130 with the interaction 110 by the interacting user 102, and upon detecting a similarity between the second interaction and the interaction 110, may determine that the usage 116 by the interacting user 102 is of interest 118 to the interested user 130. As a second such example, the interaction 110 of the interacting user 102 with the resource 108 may result in a response by the resource 108, and an embodiment may determine that the response is of interest to the interested user 130 (e.g., a query into a data set that produces results involving a topic or record that is of interest to the interested user 130). An embodiment may therefore determine that the usage 116 is of interest to the user 130 due to the contents of the result or response of the resource 108 to the usage 116.

As a fourth variation of this third aspect, an interested user 130 may indicate, either explicitly or tacitly, a personal interest 128 in the resource 108 (e.g., the interested user 130 may frequently view or utilize the resource 108). As a first such example, an interested user 130 may simply indicate that a resource 108 is of interest to the interested user 130, and may have requested notification of usages 116 of the resource 108 that are identified as of interest 118. An embodiment may notify the interested user 130 of any usages 116 of the identified resource 108 by interacting users 102 of the organization 104 that are deemed to be of interest. For example, the interacting user 102 may initiate an identification that a particular usage 116 of the resource 108 is of interest 118, and the interested user 130 may therefore be notified. As a second such example, an embodiment may receive from the interested user 130 a trigger identifying a trigger threshold of usages 116 of the resource 108 (e.g., a maximum amount of data involved in the queries 112). An embodiment of the techniques presented herein may therefore determine that the usage 116 is likely of interest to the interested user 130 when the usage 116 of the resource 108 by the interacting user 102 exceeds the trigger threshold of the trigger received from the interested user 130.

As a fifth variation of this third aspect, the determination of the interest 118 of the interested user 130 may be included in the notification of to the interested user 130 of the usage 116. For example, the determination that the usage 116 is of interest 118 to the interested user 130 may be based upon to an interest basis, and the notification may inform the interested user 130 of the interest basis (e.g., that the usage 116 was initiated by an interacting user 102 with whom the interested user 130 has an organizational association 802; that the usage 116 involves a resource 108 for which the interested user 240 has an administrative responsibility 806; and/or that the usage 116 produced a result 114 that is of interest 118 of the interested user 130). Many such scenarios may be devised for identifying the interested users 130 of the organization 104 for whom the usage 116 of the resource 108 by the interacting user 102 is of interest, in accordance with the techniques presented herein.

E4. Notifying and Presenting Usages to Interested Users

A fourth aspect that may vary among embodiments of the techniques presented herein involves the manner of notifying and presenting usages 116 of a resource 108 by an interacting user 102 of an organization 104 to interested users 130 of the organization 104.

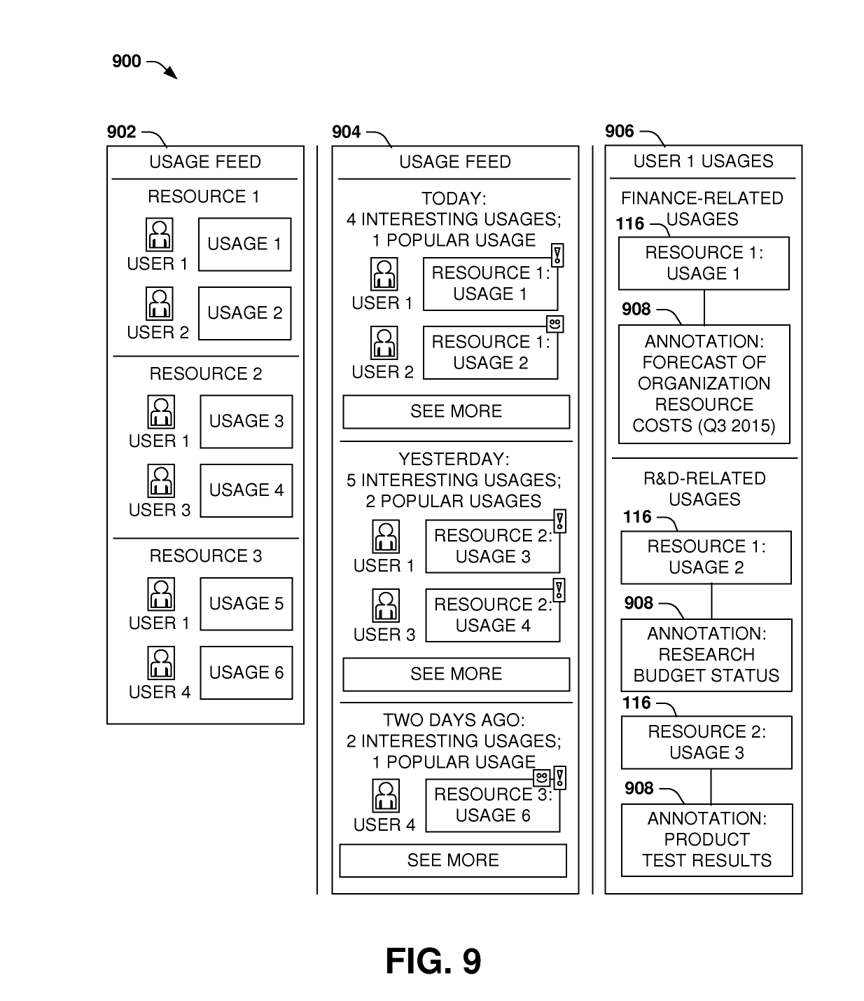

FIG. 9 is an illustration of an example scenario set featuring three variations in the presentation of usages 116 of a resource 108 by interacting users 102. As a first variation of this fourth aspect, the usages 116 may be presented as a usage feed, comprising a first usage 116 by a first interacting user 102 with a first resource 108, and a second usage 116 by a second interacting user 102 with a second resource 108. The interested user 130 may be presented with a usage feed of various resources 108 by various interacting users 102, wherein the usage feed includes the first usage 116 of the first resource 108 by the first interacting user 102 and the second usage 116 of the second resource 108 by the second interacting user 102.

As a second variation of this fourth aspect, the usages 102 of a usage feed may be sorted according to a sort criterion to produce a sorted usage catalog. Such sort criteria may be selected from a sort criterion set to produce a sorted usage catalog for presentation to the interested user 130. As a first such example, the sort criterion may include the resource 108 involved in the interaction 110. As a second such example 904, the sort criterion may include a usage time of the usage 116 of the resource 108 by the interacting user 102, e.g., usages 116 occurring within each 24-hour block of time. Moreover, where respective interactions 110 of the interacting user 102 with the resource 108 occur at an interaction time that is within a time range, the usage feed may include a usage summary of usages 116 of interacting users 102 with the selected resource 108 during the time range (e.g., a total count, cost, and/or performance of the aggregate usages 116 of the resource 108 within the time range). As a third such example 906, the sort criterion may include a context in which the interacting user 102 interacted with the resource 108 (e.g., the focus or role of the interacting user 102 to which the usage 116 relates).

As a third variation of this fourth aspect, an embodiment of the techniques presented herein may determine a usage trend of the usage catalog with the selected resource 108, such as whether usages 110 that are of interest 118 are increasing, decreasing, accelerating, decelerating, or changing in nature over time. The embodiment may notify the interested user 130 of the usage trend of interacting users 102 with the selected resource 108. As one such example, an embodiment of the techniques presented herein may determine usage trends for respective resources 108 of a resource set of the organization 104, and may rank the respective selected resources 108 of the resource set according to the usage trends. For example, a usage 116 of a particular resource 108 may be identified as popular among interested users 130, and may be identified as having a high and/or trending popularity as one such usage trend. The ranking of the usage trends may be presented with the usage catalog; e.g., the usage feed 904 may include indicators that a particular usage 116 of a particular resource 108 is of interest 108 and/or is popular among the interested users 130 of the organization 130.

As a fourth variation of this fourth aspect, the usages 116 of the resources 108 may include one or more annotations 908 of the usage 116 received from the interacting user 102 and/or an interested user 130. An embodiment may store the annotations 908 with the usage 116, and present the annotations 908 of the usage 116 to the interested user 130 (e.g., as part of the usage feed 904, usage catalog 212, and/or usage replay 218 of the usage 108).

As a fifth variation of this fourth aspect, based upon the usages 116 of interacting users 102 with a resource 108 during a time range, an embodiment may predict a future indicator of usages 116 of interacting users 102 with the selected resource 108 (e.g., determining that more interacting users 102 are likely, in the near future, to invoke a particular usage 116 that is identified of high interest 118). The embodiment may present the future indicator of usages 116 of the selected resource 108 to the interested user 130. Many such variations may be included in the presentation of the usages 116 of the resources 108 by the interacting users 102 to the interested users 130 of an organization 104 in accordance with the techniques presented herein.

E5. Participation by Individuals and/or Resources Outside of Organization

A fifth aspect that may vary among embodiments of the techniques presented herein involves the participation, in the techniques presented herein.

As a first variation of this fifth aspect, in addition to monitoring the usage of a resource 108 by users 102 within the organization 104, the techniques presented herein may involve monitoring the usage 116 of resource 108 by users 102 outside of the organization 104. For example, the organization 104 may provide public access to a particular resource 108, and when an interested user outside of the organization 110 interacts with the resource 108 of the organization 104 in a manner that produces an interesting result, notifications of such usage 116 may be distributed to interested users 130 within the organization 104.

As a second variation of this first aspect, in addition to monitoring the resources 108 of the organization 104, the monitoring may also monitor usages 116 of resource 108 outside of the organization 104, such as publicly accessible resources 108 that the users 102 of the organization 104 utilize. For example, the organization 104 may frequently utilize a publicly available resource, such as a database of information published by a government, and users 102 of the organization 104 may be interested in learning of usages 116 of the resource 108 by interested users 130 of the organization 104. The monitoring may therefore be applied to resources 108 outside of the organization 104, and notifications of interesting usages 116 of such resources 108 may be transmitted to interested users 130 within the organization 104. Moreover, the usages 116 of such resources 108 may originate within the organization 104 (e.g., a monitoring agent that monitors network accesses of resources 108 within the organization 104 may detect and report such usages 116) and/or usages 116 that originate outside of the organization 104 (e.g., a device of the interacting user 102 may monitor the user's usages 116 of resources 108, even when the interacting user 102 is utilizing a network that is not managed by the organization 104).

As a third variation of this first aspect, the determination and/or notification of interested users 130 may include individuals outside of the organization 104. For example, a resource 108 of the organization 104 may be utilized by users outside as well as inside the organization 104, and a significant number may comprise interested users 130 both within and outside the organization 104. Accordingly, notifications of interesting usages 116 of a resource 108 may be transmitted to interested users 30 outside of the organization 104 as well as inside of the organization 104.

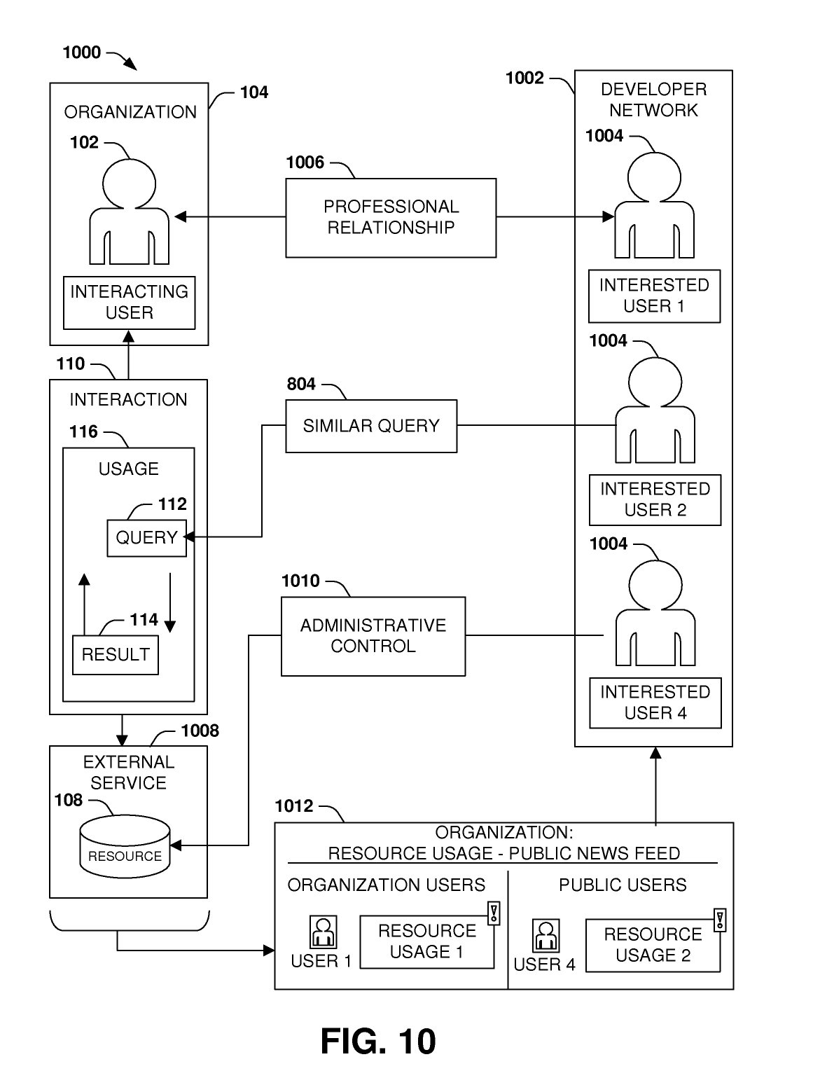

FIG. 10 presents an illustration of an example scenario 1000 featuring the extension of the techniques presented herein to include users and/or resources 108 outside of the organization 104. In this example scenario 1000, a user 102 of an organization 104 engages in an interaction 110 of a resource 1008 that is provided by an external service 1008 outside of the organization 104, such as a publicly accessible database published by a government. The interaction 110 is deemed to include a usage 116 that may be interesting to some interested users 130 outside as well as inside of the organization 104, such as members of a developer network 1002 of interested users 1004 who frequently utilize the resource 108. As a first such example, the interacting user 102 may have a professional relationship 1006 with a first external user 1004 outside of the organization 104, where the professional relationship 1006 suggests that the first external user 1004 may be interested in the usage 116 of the external resource 108 (e.g., the first external user 1004 may comprise a former colleague, teacher, student, or mentor of the interacting user 102, and details of a biography of the first external user 1004, the professional relationship 1006, and/or communication between the interacting user 102 and the first external user 1004 suggest that the first external user 1004 may have an interest in the usage 116). As a second such example, a second external user 1004 of the developer network 1002 may invoke a similar query 804 on the resource 108 that is similar to the usage 116, and may therefore be predicted to have an interest in the usage 116. As a third such example, a third external user 1004 may have administrative control 1010 over the resource 108 of the external service 1008, such as a developer who created or maintains the resource 108. These and other external users 1004 may be determined to be interested in the usage 116 of the resource 108 by the interacting user 102, and/or the interaction 110 of such external users 1004 with resources 108 within and/or outside of the organization 104 may be monitored to detect further usages 116 that may be of interest. Moreover, the organization 104 may publish a public news feed 1012 that describes the usage of the resource 108 by interacting users 102 inside and/or outside of the organization 104, in order to notify interested users 130 inside and/or outside of the organization 104 of interesting usages 116 of the resource 108. In this manner, users outside of the organization 104 may be included in the monitoring and/or notification of usages 116 of resource 108 inside and/or outside of the organization 104. Many such variations may enable external users and/or resources to participate in embodiments of the techniques presented herein.

### F. Computing Environment

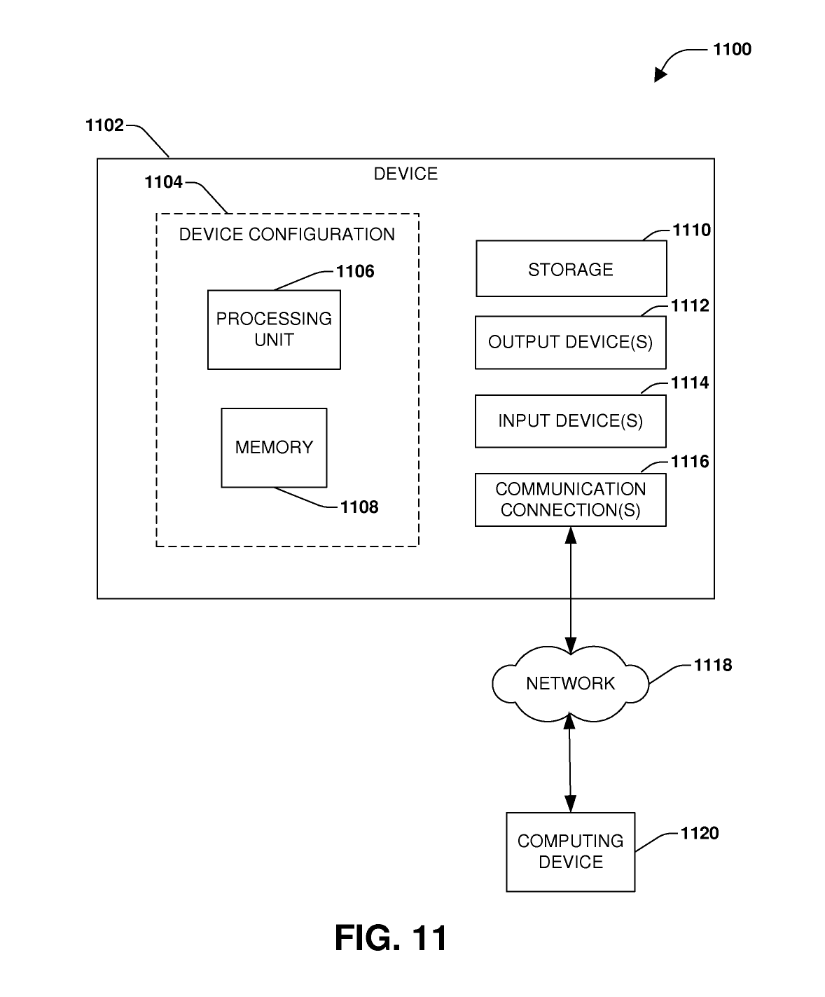

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example) or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 1108 and storage 1110 are examples of computer storage media. Computer-storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 920 accessible via network 1118 may store computer readable instructions to implement one or more embodiments provided herein. Computing device 1102 may access computing device 920 and download a part or all of the computer readable instructions for execution. Alternatively, computing device 1102 may download pieces of the computer readable instructions, as needed, or some instructions may be executed at computing device 1102 and some at computing device 920.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A device that describes usages of a resource to an interested user within an organization, the server comprising:
a processor;
a display; and
a memory storing instructions that, when executed on the processor, provide a system comprising:
a resource usage monitor that, responsive to an interaction of an interacting user of the organization with the resource:
monitors the interaction to detect a usage of the interacting user with the resource, and
stores the usage of the interacting user with the resource; and
a resource usage notifier that:
notifies the interested user of the usage of the interacting user with the resource; and
responsive to receiving from the interested user a request to describe the interaction, replays on the display, for the interested user, the usage of the interacting user with the resource.

2. The system of claim 1, wherein:
the interaction of the interacting user with the resource further comprises an interaction sequence of at least two actions invoked by the interacting user upon the resource;
the resource usage monitor stores the at least two actions comprising the interaction sequence of the interacting user with the resource; and
the resource usage notifier replays, for the interested user, the interaction sequence of the at least two actions of the interacting user with the resource.

3. The system of claim 2, wherein:
respective actions of the interacting user with the resource result in a response by the resource to the action; and
for the respective actions:
the resource usage monitor stores the response of the resource to the action; and
the resource usage notifier replays, for the interested user, the response of the resource to the action.

4. The system of claim 1, wherein:
the interaction of the interacting user with the resource occurs at an interaction time that is within a time range; and
the resource usage monitor further records the usage in a usage catalog of usages of the resource occurring within the time range.

5. A method of describing usages of a resource to an interested user within an organization, the method involving a device having a processor and comprising:
executing, on the processor, instructions that cause the device to:
for an interacting user of the organization, monitor an interaction of the interacting user with the resource to detect a usage of the interacting user with the resource;
determine whether the interested user is interested in the usage of the resource; and
responsive to determining that the interested user is interested in the usage of the resource:
notify the interested user of the usage of the resource by the interacting user; and
replay, for the interested user, the usage of the resource by the interacting user.

6. The method of claim 5, wherein determining whether the interested user is interested in the usage of the resource further comprises: identifying an association, within the organization, between the interacting user and the interested user.

7. The method of claim 5, wherein determining whether the interested user is interested in the usage of the resource further comprises: determining that the interested user is an administrator of the resource.

8. The method of claim 5, wherein:
the instructions further cause the device to receive from the interested user a trigger identifying a trigger threshold of usages of the resource; and
determining whether the interested user is interested in the usage of the resource further comprises: determining that the usage of the resource by the interacting user exceeds the trigger threshold of the trigger received from the interested user.

9. The method of claim 5, wherein determining whether the interested user is interested in the usage of the resource further comprises:
determining that the interested user has requested notification of usages of the resource that are identified as interesting; and
receiving, from the interacting user, an identification that the usage of the resource is of interest.

10. The method of claim 5, wherein:
the interaction of the interacting user with the resource result in a response by the resource to the interaction; and
determining whether the interested user is interested in the usage of the resource further comprises: determining whether the interested user is interested in the response of by the resource to the interaction.

11. The method of claim 5, wherein:
the interested user has initiated a second interaction with the resource; and
determining whether the interested user is interested in the usage of the resource further comprises: comparing the second interaction of the interested user with the interaction by the interacting user to detect a similarity between the second interaction and the interaction.

12. The method of claim 5, wherein:
determining whether the interested user is interested in the usage further comprises: determining whether a second interested user, outside of the organization, is interested in the usage of the resource; and
notifying the interested user of the usage further comprises: notifying the second interested user outside of the organization about the usage of the resource by the interacting user.

13. A method of presenting usages of resources to an interested user within an organization on a device having a processor, the method comprising:
executing, on the processor, instructions that cause the device to:
monitor an interaction of an interacting user of the organization with a resource to:
detect a usage of the resource by the interacting user; and
store the usage in a usage catalog of the interacting user;
present, to the interested user, the usage catalog of the interacting user with respective resources; and
responsive to a selection, by the interested user, of a selected usage from the usage catalog, replay the selected usage of the resource by the interacting user for the interested user.

14. The method of claim 13, wherein presenting the usage catalog further comprises:
sorting the usage catalog into a sorted usage catalog, wherein respective usages by the interacting user with a selected resource are sorted according to a sort criterion selected from a sort criterion set comprising:
the selected resource of the interaction;
a usage time of the usage of the selected resource by the interacting user; and
a context in which the interacting user interacted with the selected resource; and
presenting the sorted usage catalog of the interacting user to the interested user.

15. The method of claim 13, wherein:
the interested user is determined to be interested in a first usage by a first interacting user with a first resource, and a second usage by a second interacting user with a second resource; and
presenting the usage catalog to the interested user further comprises: presenting, to the interested user, a usage feed of resources by interacting users, wherein the usage feed includes:
the first usage of the first resource by the first interacting user, and
the second usage of the second resource by the second interacting user.

16. The method of claim 13, wherein:
the interaction of the interacting user with the resource occurs at an interaction time that is within a time range;
presenting the usage catalog to the interested user further comprises: presenting, to the interested user, a usage summary of usages of interacting users with the selected resource during the time range.

17. The method of claim 16, wherein presenting the usage catalog to the interested user further comprises:
based upon the usages of interacting users with the selected resource during the time range, predict a future indicator of usages of interacting users with the selected resource; and
present the future indicator of usages of the selected resource to the interested user.

18. The method of claim 13, wherein presenting the usage catalog to the interested user further comprises:
determining a usage trend of the usage catalog with the selected resource; and
notifying the interested user of the usage trend of interacting users with the selected resource.

19. The method of claim 18, wherein:
determining the usage trend further comprises: for respective selected resources of a resource set of the organization, determining a usage trend of interacting users with the selected resource;
executing the instructions on the processor further causes the device to rank the respective selected resources of the resource set according to the usage trend; and
presenting the usage catalog to the interested user further comprises: presenting, to the interested user, a usage trend of usages of the respective selected resources of the resource set.

20. The method of claim 13, wherein:
executing the instructions further causes the device to, responsive to receiving, from the interacting user, an annotation of the usage, store the annotation with the usage; and
replaying the selected usage of the resource by the interacting user further comprises: presenting, to the interested user, the annotation of the usage received from the interacting user.
